(19) United States
(12) Patent Application Publication
(10) Pub. No.: US 2018/0092389 A1
(43) Pub. Date: Apr. 5, 2018

(54) FLAVOR, ODOR, AND/OR COLORANT COMPOSITIONS WITH OLEAGINOUS MICROORGANISMS AND RELATED METHODS

(71) Applicant: Solazyme Roquette Nutritionals, LLC, South San Francisco, CA (US)

(72) Inventor: Leslie M. Norris, San Rafael, CA (US)

(73) Assignee: Solazyme Roquette Nutritionals, LLC, South San Francisco, CA (US)

(21) Appl. No.: 15/782,708

(22) Filed: Oct. 12, 2017

Related U.S. Application Data
(63) Continuation of application No. 13/886,690, filed on May 3, 2013, now abandoned.
(60) Provisional application No. 61/642,724, filed on May 4, 2012.

(51) Int. Cl. A21D 2/36

(52) U.S. Cl. CPC A23L 17/60; A21D 2/36; A23L 27/10; A23L 27/20; A23L 5/42; A23L 29/065; A23L 5/46

(57) ABSTRACT

The present invention relates to methods for producing a dried flavor, fragrance (e.g., odor), and/or color composition and products produced using the composition. The present invention also provides methods for producing a dried flavoring composition and products that include the composition. In general, the methods include the steps of: a) combining a flavorant, odorant and/or colorant with oleaginous cells to provide a mixture; and, b) drying the mixture to produce a dried composition.

### CROSS-REFERENCES TO RELATED APPLICATIONS

This application is a continuation of U.S. patent application Ser. No. 13/886,690, filed May 3, 2013, entitled “FLAVOR, ODOR, AND/OR COLORANT COMPOSITIONS WITH OLEAGINOUS MICROORGANISMS AND RELATED METHODS”, which claims priority under 35 U.S.C. § 119(e) to U.S. provisional application No. 61/642,724, filed May 4, 2012, entitled “FLAVOR, ODOR, AND/OR COLORANT COMPOSITIONS WITH OLEAGINOUS MICROORGANISMS AND RELATED METHODS”, the entire contents of which are hereby incorporated by reference.

### TECHNICAL FIELD

The present invention generally relates to storage and delivery of flavor, odor and/or colorant, especially for use with food and personal care products. It more specifically relates to compositions that include flavoring, odorant, and/or colorant compounds in combination with oleaginous microorganisms, and methods of making the compositions.

### BACKGROUND

Algae have long been looked to as a potential source of food. While certain types of algae, primarily seaweed, do indeed provide important foodstuffs for human consumption, the promise of algae as a foodstuff has not been fully realized. Algal powders made with algae grown photosynthetically in outdoor ponds or photobioreactors are commercially available but have a deep green color (from the chlorophyll) and a strong, unpleasant taste. When formulated into food products or as nutritional supplements, these algal powders impart a visually unappealing green color to the food product or nutritional supplement and have an unpleasant fishy or seaweed flavor.

WO2010/120923, WO2010/045368, and WO2011/130578 disclose methods of making and using microalgal biomass, and especially oleaginous cell powder of Chlorella protothecoides as a food.

### SUMMARY OF THE INVENTION

An illustrative embodiment of the present invention, is a composition, for use in flavoring, odorizing and/or coloring a product. The composition consists essentially of particles, film, or flakes comprising one or more of a flavorant, odorant, or colorant (e.g., a pigment) and cells of an oleaginous microorganism.

In various specific embodiments, the composition can include one or more excipients. The excipients can be chosen from, for example, a filler, binder, film-former, stabilizer, or preservative.

In specific embodiments, the oleaginous cells of the composition can be 10-90, 30-70, or 40-60 percent lysed and can include 10-90, 20-80, 30-70, or 40-60 percent triglyceride by dry cell weight. The oleaginous microorganism can be an oleaginous microalgae. For example, the oleaginous microalgae can be of the genus Chlorella or Prototheca, including, Chlorella protothecoides or Prototheca moriformis.

In specific embodiments, the oleaginous microorganism can be cultivated heterotrophically, in the dark. The cells of the microorganism can have less than

2.5% DHA (docosahexaenoic acid); less than 2 ppm chlorophyll; less than 500 ppm of color generating impurities; and/or be lacking in an unpleasant odor.

Another embodiment of the invention features a product that includes the composition, as described above and one or more additional ingredient(s). Prior to inclusion of the composition in the product, the composition has a higher concentration of the flavorant, odorant and/or colorant than the product. Optionally, the product is a food or personal care product.

Yet another embodiment of the invention features a method for producing a dried flavorant, odorant, and/or colorant composition. The method includes combining a flavorant, odorant, and/or colorant with oleaginous microbial cells and optionally, one or more excipients to provide a mixture, and drying the mixture to produce the dried composition.

In specific embodiments of this method, the oleaginous microbial cells are microalgal cells, optionally selected from the genus Chlorella or the genus Prototheca. The microbial cells can be grown heterotrophically, in the dark. The dried composition can be further incorporated into a food product or personal care product.

In specific embodiments of the method, the cells can be between approximately 10-90, 20-80, 30-70 or 40-60 percent lysed. The cells can be 10-90, 20-80, 30-70, or 40-60 percent triglyceride by dry cell weight.

The cells can have less than 2.5% DHA, less than 2 ppm chlorophyll, less than 500 ppm of color generating impurities, and/or lack an unpleasant odor.

At least one excipient can be included. In specific embodiments, the excipient is a filler, binder, film-former, stabilizer, or preservative. In yet more specific embodiments, the excipient is one or more of cyclodextrin, gum arabic and maltodextrin.

In a specific embodiment, the composition is heated to approximately 90° C. to 190° C. at a pressure between 0.1 lb/in2 and 45 lb/in2 for a period of 5 minutes. As a result, less than 5.0 percent of the flavorant degrades.

In specific embodiments, the composition can be included in food products such as baked goods; fried goods; frozen goods; prepared sauces; and flavor packets.

### BRIEF DESCRIPTION OF THE DRAWINGS

The features of the invention will be more readily understood by reference to the following detailed description, taken with reference to the accompanying drawing, in which:

FIG. 1 shows a flow diagram in accordance with an embodiment of the present invention.

### DETAILED DESCRIPTION OF EMBODIMENTS OF THE INVENTION

### Definitions

As used in this description and the accompanying claims, the following terms shall have the meanings indicated, unless the context otherwise requires.

An “excipient” shall mean a substance other than the flavorant, odorant, colorant, or oleaginous microbe, whether inert or having functional attributes. Without limitation, excipients can function in a dried composition, or final product into which the composition is incorporated, as film formers, emulsifiers, fillers, binders, stabilizers, preservatives, antioxidants, or microbial growth inhibitors.

In connection with a cell or cells, “oleaginous” means that the cell or cells have a triglyceride content of 10 percent or more triglycerides by dry weight.

“Lysed” cells are those where the cellular wall and/or membrane have been disrupted. After lysis, the cell's contents may remain inside the disrupted cell wall or membrane or be at least partially ejected from the cell.

In illustrative embodiments of the present invention, oleaginous cells are combined with one or more of a flavorant, odorant or colorant. One or more excipients may also be added. When a solvent is present in the mixture, the combined cells and ingredient(s) are then dried to form a dried composition. Without limitation, the dried composition may be in the form of a film, flakes, or a powder. The dried ingredient can be incorporated into a product such as a food, beverage or personal care product.

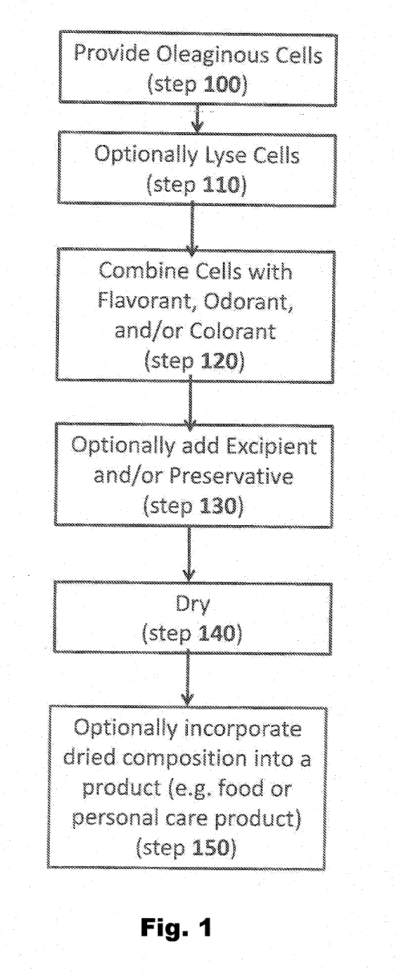

FIG. 1 shows a flow diagram of a process for making compositions according to the present invention. Oleaginous cells (step 100) are obtained. The oleaginous cells can be cultivated using known methods, and are provided in liquid or dry form. The oleaginous cells can include, for example, 10 percent to 90 percent triglycerides, 20 percent to 80 percent triglycerides, 30 percent to 70 percent triglycerides, or 40 percent to 60 percent triglycerides.

The oleaginous cells may be obtained from a culture of oleaginous microorganisms such as oleaginous microalgae or oleaginous yeast. The cells are preferably cultivated heterotrophically, in the dark, using a fixed carbon source (i.e., one other than carbon dioxide such as glucose, sucrose, glycerol, hydrolyzed cellulosic material, etc.). The triglyceride content of the cells can be increased by cultivation under nutrient limiting conditions, especially by limiting nitrogen.

In a preferred embodiment, the oleaginous cells are microalgal cells. Nonlimiting examples of oleaginous microalgae include: Achnanthes orientalis, Agmenellum, Amphiprora hyaline, Amphora coffeiformis, Amphota coffeiformis linea, Amphora coffeiformis punctate, Amphora coffeiformis taylori, Amphora coffeiformis tenuis, Amphora delicatissima, Amphora delicatissima capitata, Amphora sp., Anabaena, Ankistrodesmus, Ankistrodesmus, Ankistrodesmus falcatus, Boekelovia hooglandii, Borodinella sp., Botryococcus braunii, Botryococcus sudeticus, Carteria, Chaetoceros gracilis, Chaetoceros muelleri, Chaetoceros muelleri subsalsum, Chaetoceros sp., Chlorella anitrata, Chlorella Antarctica, Chlorella aureoviridis, Chlorella candida, Chlorella capsulate, Chlorella desiccate, Chlorella ellipsoidea, Chlorella emersonii, Chlorella fusca, Chlorella fusca var. vacuolata, Chlorella glucotropha, Chlorella infusionum, Chlorella infusionum var. actophila, Chlorella infusionum var. auxenophila, Chlorella kessleri, Chlorella lobophora, Chlorella luteoviridis, Chlorella luteoviridis var. aureoviridis, Chlorella luteoviridis var. lutescens, Chlorella miniata, Chlorella minutissima, Chlorella mutabilis, Chlorella nocturna, Chlorella parva, Chlorella photophilia, Chlorella pringsheimii, Chlorella prototecoides (including any of UTEX strains 1806, 411, 264, 256, 255, 250, 249, 31, 29, 25), Chlorella prototecoides var. acidicola, Chlorella regularis, Chlorella regularis var. minima, Chlorella regularis var. umbricata, Chlorella reisiglii, Chlorella saccharophila, Chlorella saccharophia var. ellipsoidea, Chlorella salina, Chlorella simplex, Chlorella sorokiniana, Chlorella sp., Chlorella aphaerica, Chlorella stigmatophora, Chlorella vanniellii, Chlorella vulgaris, Chlorella vulgaris f. tertia, Chlorella vulgaris var. autotrophica, Chlorella vulgaris var. viridis, Chlorella vulgaris var. vulgaris, Chlorella vulgaris var. vulgaris f. tertia, Chlorella vulgaris var. vulgaris f. viridis, Chlorella xanthella, Chlorella zofingiensis, Chlorella trebouxioides, Chlorella vulgaris, Chlorococcum insusionum, Chlorococcum sp., Chlorogonium, Chroomonas sp., Chrysosphaera sp., Cricosphaera sp., Crypthecodinium cohnii, Cryptomonas sp., Cyclotella cryptica, Cyclotella meneghiniana, Cyclotella sp., Dunaliella sp., Dunaliella bardawil, Dunaliella bioculata, Dunaliella granulate, Dunaliella maritime, Dunaliella minuta, Dunaliella parva, Dunaliella peircei, Dunaliella primolecta, Dunaliella salina, Dunaliella terricola, Dunaliella tertiolecta, Dunaliella viridis, Eremosphaera viridis, Eremosphaera sp., Ellipsoidon sp., Euglena, Franceia sp., Fragilaria crotonensis, Fragilaria sp., Gleocapsa sp., Gloeothamnion sp., Hymenomonas sp., Isochrysis aff. Galbana, Isochrysis galbana, Lepocinclis, Micractinium, Micractinium (UTEX LB 2614), Monoraphidium minutum, Monoraphidium sp., Nanochloris sp., Nanochloropsis salina, Nanochloropsis sp., Navicula acceptata, Navicula biskanterae, Navicula pseudotenelloides, Navicula pelliculosa, Navicula saprophila, Navicula sp., Nephrochloris sp., Nephroselmis sp., Nitschia communis, Nitzschia alexandrina, Nitzschia communis, Nitzschia dissipata, Nitzschia frustulum, Nitzschia hantzschiana, Nitzschia inconspicua, Nitzschia intermedia, Nitzschia microcephala, Nitzschia pusilla, Nitzschia pusilla elliptica, Nitzschia pusilla monoensis, Nitzschia quadrangular, Nitzschia sp., Ochromonas sp., Oocystis parva Oocystis pusilla, Oocystis sp., Oscillatoria limnetica, Oscillatoria sp., Oscillatoria subbrevis, Pascheria acidophila, Pavlov asp., Phagus, Phormidium, Platymonas sp., Pleurochrysis carterae, Pleurochrysis dentate, Pleurochrysis sp., Prototheca wickerhamii, Prototheca stagnora, Prototheca portoricensis, Prototheca moriformis, Prototheca zopfii. Pyramimonas sp., Pyrobotrys, sarcinoid chrysophyte, Scenedesmus armatus, Schizochytrium, Spirogyra, Spirulina platensis, Stichococcus sp., Synechococcus sp., Tetraedron, Tetraselmis sp., Tetraselmis suecica, Thalassiosira weissflogii, and Viridiella fridericiana.

Alternatively, the oleaginous cells can also be oleaginous yeast cells. For example, the yeast can be of the species Cryptococcus curvatus, Cryptococcus terricolus, Candida sp., Lipomyces starkeyi, Lipomyces lipofer, Endomycopsis vernalis, Rhodotorula glutinis, Rhodotorula gracilis, and Yarrowia lipolytica.

In preferred embodiments, the oleaginous cells are microalgal cells from the genus Chlorella (e.g., Chlorella protothecoides) or the genus Prototheca (e.g., Prototheca moriformis).

In certain cases, the oleaginous cells are microalgae that are cultivated heterotrophically, in the dark, so as to include less than 1000 ppm, 750 ppm, 500 ppm, or 250 ppm of color generating impurities. The cells may lack a visible green color. Nonlimiting examples of such impurities include chlorophyll and carotenoids. In a specific test for color, 10 mg of dried microalgae are suspended in 1 mL of water and the absorbance is measured at 500 nm or 660 nm. In specific embodiments, the absorbance so measured at 500 nm and/or 660 nm is less than or equal to 1, 0.1, 0.01, or 0.001 OD (Optical Density) unit.

In an embodiment, the oleaginous cells have between 20-115 μg/g of total carotenoids, including 20-70 μg/g lutein and preferably have less than 10 μg/g lutein.

In order to reduce unpalatable flavor and odor, cells with low levels of highly unsaturated fatty acids (fatty acids having more than three double bonds) may be used. For example, the microalgal triglyceride is less than 5%, 2.5%, 1%, or is substantially free of docosahexaenoic acid (DHA, a C22:6 fatty acid). The cells may also have 30% or greater monounsaturated fatty acids.

In general, the cells can be lacking in unpleasant taste or odor.

The cells may be mutated to further reduce the color. For example, classical mutagenesis may be used to create variability in a population of microalgae and the resulting cells screened for low color. Screening can be accomplished, for example, by: limiting dilution and culture in 96 well or 384 well plates followed by absorbance measurements in a plate reader or making chemical measurements (e.g., using chromatography, mass spectrometry or other methods). In the case of heterotrophically cultivated Chlorella, it has been found that mutants can be obtained by classical mutagenesis that are reduced in yellow color compared to the parent strains.

The cells are optionally lysed or partially lysed (step 110). For example, lysis may be accomplished by mechanical, enzymatic, chemical, viral, electrical, ultrasonic, osmotic or other mechanism. Illustrative compositions of the present invention include a population of cells that is 10 to 90, 20 to 90, or 30 to 90 percent lysed. As a result of lysis, the cells may be made more permeable to various flavorants, odorants or colorants. Lysis can be performed before or after drying of the cells. In a preferred embodiment, the cells are dried and then milled to lyse. Alternatively, unlysed cells are used that are permeable to a given flavorant, odorant, or colorant.

The unlysed, lysed, or partially lysed cells are mixed with one or more flavorant, odorant, or colorant to form a mixture (step 120). The flavorant, odorant, and/or colorant can be, without limitation, a substantially pure compound, or can be a mixture or natural extract. These categories are not mutually exclusive. It is known in the art that flavorants can act as odorants and vice versa. Thus, embodiments of the invention include combining the oleaginous microbial cells with a substance to impart flavor or odor characteristics to a food or other substance. In addition, certain flavorants or odorants are also colored and can be used to impart flavor and/or odor together with color.

The flavorant, odorant, and/or colorant may be selected from the many known in the art. The flavorant, odorant and/or colorant may be in an aqueous or nonaqueous solvent. Where the flavorant, odorant, and/or colorant is fat soluble, it may partly or entirely partition into the triglyceride produced by the oleaginous microbe. For example, if the microbe is unlysed, or is partly intact, and the substance is fat soluble, the substance may accumulate in lipid storage vesicles of the microbe (e.g., lipid filled plastids of an oleaginous microalgae). In this way, the fat soluble flavorant, odorant and/or colorant may be “encapsulated” in the cell or cell fragment. Alternately, the cell may be lysed and its lipid contents coat the outside of the cell; in such cases, a fat soluble substance can be carried in the lipidic coating. These various forms may also coexist, such as when a partially lysed population of oleaginous cells is used.

Nonlimiting examples of flavorants or odorants include flavorants or odorants based on aldehydes, ketones, alcohols, terpenes, pyrazines, thiazols, dienals.

Examples of aldehyde flavorants include acetaldehyde (apple); benzaldehyde (cherry, almond); anisic aldehyde (licorice, anise); cinnamic aldehyde (cinnamon); citral (e.g., geranial, alpha citral (lemon, lime) and neral, beta citral (lemon, lime)); decanal (orange, lemon); ethyl vanillin (vanilla, cream); heliotropine, i.e., piperonal (vanilla, cream); vanillin (vanilla, cream); α-amyl cinnamaldehyde (spicy fruity flavors); butyraldehyde (butter, cheese); valeraldehyde (butter, cheese); citronellal (modifies, many types); decenal (citrus fruits); aldehyde C-8 (citrus fruits); aldehyde C-9 (citrus fruits); aldehyde C-12 (citrus fruits); 2-ethyl butyraldehyde (berry fruits); hexenal, i.e., trans-2 (berry fruits); tolyl aldehyde (cherry, almond); veratraldehyde (vanilla); 2-6-dimethyl-5-heptenal, i.e., Melonal™ (melon); 2,6-dimethyloctanal (green fruit); 2-dodecenal (citrus, mandarin); and combinations thereof.

Examples of ketone based flavorants or odorants include d-carvone (caraway); 1-carvone (spearmint); diacetyl (butter, cheese, “cream”); benzophenone (fruity and spicy flavors, vanilla); methyl ethyl ketone (berry fruits); maltol (berry fruits) menthone (mints), methyl amyl ketone, ethyl butyl ketone, dipropyl ketone, methyl hexyl ketone, ethyl amyl ketone (berry fruits, stone fruits); pyruvic acid (smokey, nutty flavors); acetanisole (hawthorn heliotrope); dihydrocarvone (spearmint); 2,4-dimethylacetophenone (peppermint); 1,3-diphenyl-2-propanone (almond); acetocumene (orris and basil, spicy); isojasmone (jasmine); d-isomethylionone (orris like, violet); isobutyl acetoacetate (brandy-like); zingerone (ginger); pulegone (peppermint-camphor); d-piperitone (minty); 2-nonanone (rose and tea-like); and combinations thereof.

Examples of alcohol based flavorants or odorants include anisic alcohol or p-methoxybenzyl alcohol (fruity, peach); benzyl alcohol (fruity); carvacrol or 2-p-cymenol (pungent warm odor); carveol; cinnamyl alcohol (floral odor); citronellol (rose like); decanol; dihydrocarveol (spicy, peppery); tetrahydrogeraniol or 3,7-dimethyl-1-octanol (rose odor); eugenol (clove); p-mentha-1,8dien-7-O or perillyl alcohol (floral-pine); alpha terpineol; mentha-1,5-dien-8-ol 1; mentha-1,5-dien-8-ol 2; p-cymen-8-ol; and combinations thereof.

Examples of colorants that can be used include artificial colorings such as FD&C blue No. 1, FD&C Blue No. 2, FD&C Green, No. 3, FD&C Red No. 40, FD&C Red No. 3, FD&C Yellow No. 5, FD&C Yellow, No. 5, or natural food dyes such as caramel coloring, annatto, cochineal, curcuminoids, saffron, paprika, elderberry juice, pandan, and butterfly pea.

One or more excipients are optionally added to the mixture (step 130). Among others, excipients can include preservatives (including antioxidants and antimicrobials), fillers, binders, and film-forming substances. Recognizing that the oleaginous cells themselves can function to stabilize flavor, odor or color, additional stabilizing excipients (e.g., cyclodextrins) can be added as preservatives.

In an embodiment, the composition forms an emulsion prior to drying. Film formers such as gum arabic may be added to aid in emulsion formation and/or protect the flavor/oil mixture during drying. The resulting dried product may be in the form of flakes, powder, or micronized powder. The emulsion formation may be entirely or primarily due to the oleaginous cells, or can be assisted with the addition of emulsifying agents and/or film-forming excipients. For example, gum arabic can be combined with oleaginous microalgae and a flavorant, odorant and/or colorant and dried to form a film or flakes.

Other excipients that may be used in compositions of the present invention include, without limitation: carbohydrates; gums; and, proteins. Nonlimiting examples of carbohydrates include starch, modified starch, maltodextrins, and cyclodextrins (e.g., β-cyclodextrin). Nonlimiting examples of carbohydrates include gum arabic, maltodextrin and mixtures of gum arabic and maltodextrin. Nonlimiting examples of proteins include sodium caseinate, whey protein isolates, algal protein and soy protein isolates.

Nonlimiting examples of optional preservatives that may be used include antimicrobial preservatives and antioxidants. Antimicrobial preservatives include, without limitation, the following: sorbic acid and its salts, benzoic acid and its salts, calcium proprionate, sodium nitrite, sodium nitrate, sulfites (e.g., sulfur dioxide, sodium bisulfite, potassium sulfite), and disodium EDTA. Examples of antioxidant preservatives include tocopherols, rosemary extract, ascorbic acid, TBHQ, propyl gallate, butylated hydroxyanisole and butylated hydroquinone.

The mixture of oleaginous cells, flavorant, odorant and/or colorant and optional preservative, film former, or other excipient(s) can be dried. (step 140). In a specific embodiment, heterotrophically cultivated Chlorella cells (lysed, partly lysed, or unlysed) having between 30 and 70 percent triglyceride by dry cell weight are combined with a flavorant, odorant and/or colorant together with a film forming substance such as gum arabic and dried to form fine particles or flakes.

Any suitable device and method can be used to dry the wet mixture. Nonlimiting examples of drying devices and corresponding methods include: coacervation; co-crystallization; molecular inclusion; spray drying; freeze drying; spray cooling/chilling; and extrusion.

Drying may be used at intermediate stages as well. For example, the oleaginous cells can be dried prior to combining with a solution or suspension containing the flavorant, odorant, and/or colorant, and one or more optional excipients. This mixture can then be dried. Alternatively, all the ingredients can be combined in dry form with mechanical mixing for a time and at a temperature sufficient to mix the added ingredients with the oleaginous cells.

Coacervation or co-crystallization may also be used. Coacervation is an encapsulation process occurring in colloidal solutions. It may be simple or complex. Simple coacervation uses one polymer type and involves the addition of strongly hydrophilic agents to the colloidal solution. Complex coacervation uses two or more polymer types.

Co-crystallization is an encapsulation process where the encapsulating material(s) crystallize along with the flavorant, odorant and/or colorant. Molecular inclusion is an encapsulation typically involving O-cyclodextrin. Inclusion complexes are formed between the cyclodextrin and the flavorant, odorant and/or colorant.

In an embodiment, spray cooling or chilling is used to form particles (e.g., a powder) comprising the oleaginous cells, the flavorant, odorant and/or colorant, and the one or more optional excipients.

In an embodiment, extrusion is used to make a film or filament comprising the oleaginous cells and the flavorant, odorant and/or colorant and the one or more optional excipients. For extrusion, the flavorant, odorant and/or colorant is dispersed in an encapsulation material comprising the oleaginous cells and optional excipients and then forced through a die, forming filaments. The filaments are plunged into a desiccant liquid, which traps the flavorant, odorant and/or colorant within the encapsulation materials.

In an embodiment, the composition is spray-dried. Spray drying involves the atomization and spraying of the mixture into a hot chamber to form a film, flakes or powder. Thus, a wet mixture of flavorant, odorant and/or colorant, the oleaginous cells and one or more optional excipients in a liquid is atomized into a hot chamber. Example of spray-driers include tower, box-form, and FilterMat™ spray driers.

In certain cases, the spray dryer has a vertical parallel flow function. Such dryers are usually capable of blowing a high volume of dry gas dehumidified to 1% relative humidity (RH) or less. Nonlimiting examples of spray dryers include the micromist MD series and the hybrid granulator series manufactured by Fujisaki Electric Col, Ltd., the FSD spray dryer with internal fluid layer as manufactured by Niro Corporation, the fluid granulation spray dryer and L-8 type spray dryer manufactured by Ogawara Chemical Engineering Machine Corporation, and the DL-21 type and GB-21 type manufactured by Yamato Scientific Co., Ltd.

The spray dryer can be capable of generating liquid droplets having a mean volume diameter of approximately 0.1 μm. Oftentimes, the dryer is capable of generating liquid droplets having a mean volume diameter of approximately 0.1 μm to approximately 20 μm, 0.1 μm to approximately 10 μm, or approximately 1.0 μm to approximately 8.0 μm. When the liquid droplets are dried, a dry powder usually having a mean volume diameter of approximately 0.1 μm to approximately 15.0 μm, approximately 0.1 μm to approximately 7.0 μm, or approximately 0.7 μm to approximately 6.0 μm is prepared.

The composition can then be packaged and shipped. Alternately, the composition can be incorporated into a food product or other product (step 150). Examples of non-food products that can be odorized or colored using the composition include personal care products such as bar soap, liquid soap, shampoos, hair conditioners, lotions, lipstick, eyeliner, mascara, rouge and other cosmetics. The compositions can also be used to color or scent plastics, air fresheners or other items.

Compositions of the present invention can be included in a variety of different food types. Nonlimiting examples of such food types include: baked goods, such as bread, cakes, cookies, crackers and cereals; fried goods, such as chips; frozen goods, such as ice cream, sherbets, and popsicles; prepared sauces, such as pasta sauces, cheese-based sauce, and milk-based sauces; and, flavor packets, as used in boxed grains, pastas, stuffings and potatoes.

When flavorant compositions according to embodiments of the present invention are incorporated into food products, they can protect against flavor loss, flavor character change (fresh flavor changing to cooked flavor) and/or carry more flavor. For example, flavorant, odorant and/or colorant dried in the above-described compositions can deliver the flavor, odor or color to the finished food without loss in a hot-fill or retort process. This flavor protection and/or enhancement may be measured using a variety of methods. For instance, gas chromatography (i.e., GC), gas chromatography/mass spectrometry (i.e., GC/MS), or high performance liquid chromatography (i.e., HPLC) can be used to identify and quantify one or more specific flavorants, or their degradants, in a food product. Human sensory testing can also be used to determine flavor qualities of a food product. See, for example, ASTM 1627-11.

In an embodiment, heating a food product containing one or more compositions according to various embodiments of the present invention to approximately 90° C. to 190° C. at a pressure between 0.1 lb/in2 and 45 lb/in2, or 95° C. to 130° C. at a pressure between 15 lb/in2 and 35 lb/in2, for a period of approximately one, two, three, four or five minutes typically does not result in the degradation of more than 25 percent of a particular flavorant, odorant or colorant. The heating does not result in the degradation of more than 20 percent, 15 percent, or 10 percent of the flavorant. In certain cases, it does not result in the degradation of more than 7.5 percent, 5.0 percent, 4.0 percent, 3.0 percent or 1.0 percent of the flavorant.

Example: Vanilla Cake.

A dry powder of Chlorella protothecoides cells having approximately 50% lipid by dry cell weight and about 90% lysed was produced. A mixture of Chlorella protothecoides powder (5%), water (65%), vanilla flavoring (10%), and gum arabic (20%), all percents by weight, was mixed in a shear mixer and dried using a form of spray drying resulting in dried flakes, The flakes were incorporated into a yellow cake at a concentration of 0.1% by weight flakes. A control cake was prepared using vanilla flavoring without the Chlorella flakes. Based on taste tests, the cake made with the Chlorella flakes was higher in vanillin character when compared to the control cake.

### FURTHER DESCRIPTION OF SELECTED EMBODIMENTS OF THE INVENTION

In the following paragraphs, selected embodiments have been described by a number for easy reference. The order of the numbering does not indicate priority or preference between the various embodiments.
1. A composition for use in flavoring, odorizing and/or coloring a product, the composition consisting essentially of particles, film, or flakes comprising:
   (a) one or more of a flavorant, odorant, or colorant; and
   (b) cells of an oleaginous microorganism.
2. A composition according to embodiment 1, the composition additionally comprising one or more excipients.
3. A composition according to embodiments 1 or 2, wherein the oleaginous cells are 10-90, 30-70, or 40-60 percent lysed.
4. A composition according to any of embodiments 1 to 3, wherein the oleaginous cells comprise 10-90, 20-80, 30-70, or 40-60 percent triglyceride by dry cell weight.
5. A composition according to embodiment 2, wherein the one or more excipients comprises a filler, binder, film-former, stabilizer, or preservative.
6. A composition according to any of the preceding embodiments, wherein the oleaginous microorganism is an oleaginous microalgae.
7. A composition according to embodiment 6, wherein the microalgae is of the genus Chlorella or Prototheca.
8. A composition according to embodiment 7, wherein the microalgae are of the species Chlorella protothecoides or Prototheca moriformis.
9. A composition according to any of the preceding embodiments wherein the microorganism is cultivated heterotrophically, in the dark.
10. A composition according to any of the preceding embodiments wherein the cells have one or more of the following properties:
   (a) less than 2.5% DHA;
   (b) less than 2 ppm chlorophyll;
   (c) less than 500 ppm of color generating impurities; or
   (d) lacking in an unpleasant odor.
11. A product comprising:
   (a) the composition of any of embodiments 1 to 10; and
   (b) one or more additional ingredients,
   wherein, prior to inclusion in the product, the composition has a higher concentration of the flavorant, odorant and/or colorant than the product.
12. A product according to embodiment 11, wherein the product is a food or personal care product.
13. A method for producing a dried flavorant, odorant, and/or colorant composition, the method comprising:
   a) combining a flavorant, odorant, and/or colorant with oleaginous microbial cells and optionally, one or more excipients to provide a mixture;
   b) drying the mixture to produce the dried composition.
14. A method according to embodiment 13, wherein the oleaginous microbial cells are microalgal cells, optionally selected from the genus Chlorella or the genus Prototheca.
15. A method according to embodiment 13 or 14, wherein the microbial cells are grown heterotrophically, in the dark.
16. A method according to any of embodiments 13 to 15, wherein the dried composition is further incorporated into a food product or personal care product.
17. A method according to any of embodiments 13 to 16, wherein the cells are between approximately 10-90, 20-80, 30-70 or 40-60 percent lysed.
18. A method according to any of embodiments 13 to 17, wherein the cells are 10-90, 20-80, 30-70, or 40-60 percent triglyceride by dry cell weight.
19. A method according to any of embodiments 13 to 18, wherein the cells have one or more of the following properties:
   (a) less than 2.5% DHA;
   (b) less than 2 ppm chlorophyll;
   (c) less than 500 ppm of color generating impurities; or
   (d) lacking in an unpleasant odor.
20. A method according to any of embodiments 13 to 19, wherein the method comprises including at least one excipient, wherein the excipient is a filler, binder, film-former, stabilizer, or preservative.
21. A method according to any of embodiments 13 to 20, wherein when the composition is heated to approximately 90° C. to 190° C. at a pressure between 0.1 lb/in² and 45 lb/in² for a period of 5 minutes, less than 5.0 percent of the flavorant degrades.
22. A method according to any of embodiments 13 to 21, wherein the dried composition comprises an excipient, and the excipient is selected from a group consisting of cyclodextrin, gum arabic and maltodextrin.
23. A method for producing a food product comprising the composition according to embodiment 1, comprising the step of including the composition in a food product selected from a group consisting of: baked goods; fried goods; frozen goods; prepared sauces; and flavor packets.

1.-12. (canceled)

13. A method for producing a dried powder flavorant, composition consisting essentially of oleaginous microalgal cells, flavorant, and optionally, one or more excipients, the dried powder flavorant composition for incorporation into a finished food, the method comprising:
a) combining vanillin or vanilla with oleaginous microalgal cells and optionally, one or more excipients to provide a mixture;
b) drying the mixture to produce the dried powder flavorant compositions;
wherein the oleaginous microalgal cells are between 10-90 percent lysed and are 40-60 percent triglyceride by dry cell weight, and
wherein the dried powder flavorant composition protects against flavor loss of the vanillin or vanilla in the finished food when during the preparation of the finished food, the vanillin or vanilla exposed to temperatures of 90° C. to 190° C.

14. A method according to claim 13, wherein the oleaginous microalgal cells are selected from the genus Chlorella or the genus Prototheca.

15. A method according to claim 13, wherein the microalgal cells are grown heterotrophically, in the dark.

16.-18. (canceled)

19. A method according to claim 13, wherein the cells have one or more of the following properties:
(a) less than 2.5% DHA;
(b) less than 2 ppm chlorophyll;
(c) less than 500 ppm of color generating impurities; or
(d) lacking in an unpleasant odor.

20. A method according to claim 13, wherein the method comprises including at least one excipient, wherein the excipient is a filler, binder, film-former, stabilizer, or preservative.

21. (canceled)

22. A method according to claim 13, wherein the excipient is selected from a group consisting of cyclodextrin, gum arabic and maltodextrin.

23. (canceled)

24. A method according to claim 14, wherein the microalgal cells are Chlorella Protothecoides.
